(19) United States
(12) Patent Application Publication
(10) Pub. No.: US 2012/0174995 A1
(43) Pub. Date: Jul. 12, 2012

(54) Low Pressure / High Flow Back Pressure Device and System

(76) Inventors: Shane Bloomer, Oak Creek, WI (US); Louis D. Atkinson, New Berlin, WI (US)

(21) Appl. No.: 13/344,927

(22) Filed: Jan. 6, 2012

Related U.S. Application Data
(60) Provisional application No. 61/430,377, filed on Jan. 6, 2011.

(51) Int. Cl. F16K 1/00

(52) U.S. Cl. 137/535

(57) ABSTRACT

The present application discloses a device and an exemplary system utilizing the device for precise low pressure/high flow capability pumps. One non-limiting example of such a pump is used in the medical field and operates at approximately 0.5 cubic feet per minute at 1.5 Psi. The device of the present application regulates pressure from such a pressure pump to an output chamber by exhausting excess pressure to atmosphere once the pressure to the output chamber reaches a desired adjustable level.

### CROSS REFERENCE TO RELATED APPLICATION

The present application claims priority of U.S. Provisional Application No. 61/430,377, filed Jan. 6, 2011, the content of which is incorporated herein by reference in its entirety.

### FIELD

The present application is directed to the field of pressure regulation. More specifically, the present application is directed to the field of back pressure regulation in low pressure/high flow systems.

### BACKGROUND

Existing regulating devices and systems utilized in low pressure/high flow systems fail to maintain a stable setpoint throughout a full range of a low pressure pump, and further do not include an internal convoluted diaphragm that does not vibrate during operation. These shortcomings make for current devices that are noisy and unstable. Such devices are sometimes referred to as back-pressure regulators. Such devices exist for higher pressure applications, but there are no known devices that work precisely at low pressure/high flow conditions.

### SUMMARY

The present application discloses a device and an exemplary system utilizing the device for precise low pressure/high flow capability pumps. One non-limiting example of such a pump is used in the medical field and operates at approximately 0.5 cubic feet per minute at 1.5 Psi.

The device of the present application regulates pressure from such a pressure pump to an output chamber by exhausting excess pressure to atmosphere once the pressure to the output chamber reaches a desired adjustable level.

In one aspect of the present application a pressure regulator device includes a base portion having a supply port and a convoluted diaphragm having a u-shaped portion at an attachment point to the base portion, the convoluted diaphragm secured to seal the supply port from an exhaust chamber in the base portion with a bias force from an adjustment spring, the convoluted diaphragm further moving in a path opposite the bias in response to a predetermined pressure level at the supply port, wherein pressure is released through the exhaust chamber to an exhaust opening in the base when the predetermined pressure level is reached, and a spring cavity housing secured to the base portion and housing the adjustment spring, the spring cavity including a reference to atmosphere opening in order to maintain atmospheric pressure in the spring cavity housing.

In another aspect of the present application a pressure regulator device includes a base portion having a supply port and a convoluted diaphragm, the convoluted diaphragm secured to seal the supply port from an exhaust chamber in the base portion with a bias force from an adjustment spring, the convoluted diaphragm further moving in a path opposite the bias in response to a predetermined pressure level at the supply port, wherein pressure is released through the exhaust chamber to an exhaust opening in the base, and a spring cavity housing secured to the base portion and housing the adjustment spring, the spring cavity including a reference to atmosphere opening in order to maintain atmospheric pressure in the spring cavity housing.

In another aspect of the present application a pressure regulator device includes a base portion having a supply port and a convoluted diaphragm having a u-shaped portion at an attachment point to the base portion, the convoluted diaphragm secured to seal the supply port from an exhaust chamber in the base portion with a bias force from an adjustment spring, the convoluted diaphragm further moving in a path opposite the bias in response to a predetermined pressure level at the supply port, wherein pressure is released through the exhaust chamber to an exhaust opening in the base when the predetermined pressure level is reached, and a spring cavity housing secured to the base portion and housing the adjustment spring.

### BRIEF DESCRIPTION OF THE FIGURES

FIG. 1 illustrates a schematic diagram of an embodiment of a system of the present application.

FIG. 2 illustrates a section view of an embodiment of the device of the present application, illustrating the device in a fully open position.

FIG. 3 illustrates a section view of an embodiment of the device of the present application, illustrating the device in a closed position.

FIG. 4 illustrates a bottom view of an embodiment of the device of the present application.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

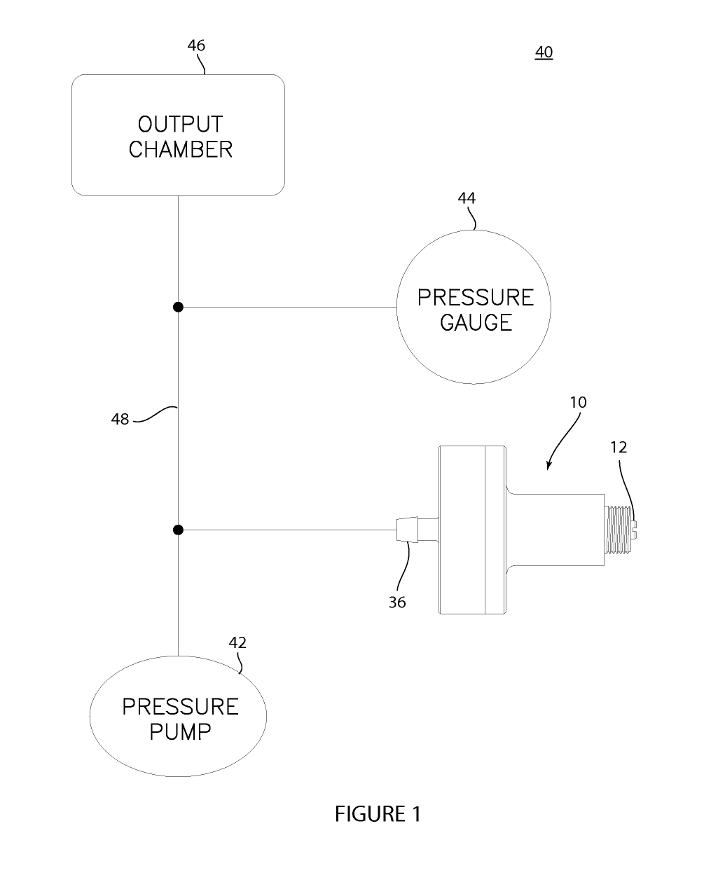

Referring to FIG. 1, in an exemplary system 40 of the present application a pressure pump 42 supplies pressurized air to an output chamber 46 through a system air line 48. The pressure that is supplied to the output chamber 46 typically needs to be regulated down to a desired and/or required setpoint. A standard in-line, pressure regulator (not shown) of the prior art would reduce the airflow to the output chamber 46, thus dramatically increasing the amount of time that it would take to fill the output chamber 46.

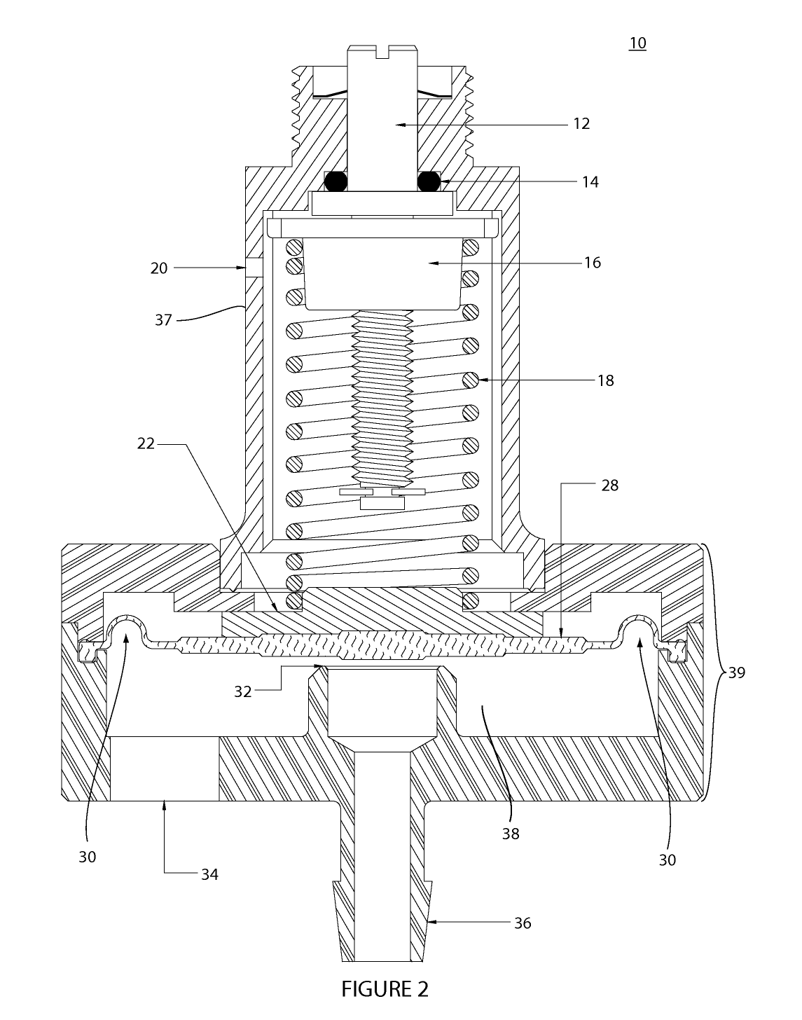

In this exemplary embodiment, the device 10 is connected in a T configuration or “tee'd” off the system air line 48 from the pressure pump 42 to the output chamber 46 as shown. This device 10 allows the pressurized air to flow from the pressure pump 42 to the output chamber 46 until the desired and/or required pressure setting of the output chamber 46 is reached, and then the excess supply of air delivered from the pressure pump 42 is exhausted out of the device 10 to atmosphere through the supply exhaust opening 34 (FIG. 2).

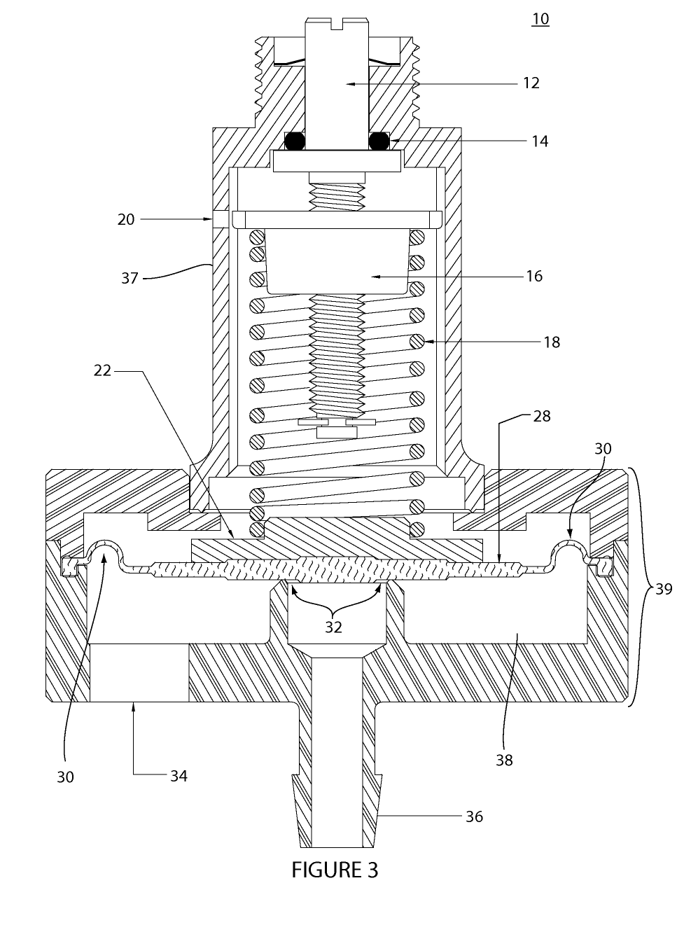

Referring to FIGS. 2 and 3 simultaneously, a section view of the device 10 of the present application is illustrated. The device 10 includes a spring cavity housing 37 and a base portion 39. The spring cavity housing 37 houses the adjustment spring 18 and the mechanism for adjusting the adjustment spring 18, including the adjustment screw 12, the o-ring 14 and the adjustment nut 16. In operation, a user utilizes a tool in order to rotate the adjustment screw 12 that in turn compresses the adjustment spring 18 between the adjustment nut 16 and a spring guide 22. The spring guide 22 is in direct contact with the convoluted diaphragm 28, and when the supply port 36 has no pressure, or pressure below the set level, the convoluted diaphragm 28 covers the supply port 36 and seals the supply port 36 by maintaining contact with a sealing ring 32 as shown in FIG. 3. The convoluted diaphragm 28 is convoluted due to a u-shaped portion 30 about the circumference of the convoluted diaphragm 28, and defined on one side by an attachment point to the base portion 39.

Still referring to FIGS. 2 and 3 simultaneously, as stated previously, the convoluted diaphragm 28 seals an exhaust chamber 38 from the supply port 36 when the pressure at the supply port 36 is below the set limit. Once the pressure at the supply port 36 exceeds the limit, then the convoluted diaphragm 28 is pushed against the bias of the compressed adjustment spring 18 and allows air to flow from the supply port 36 through the exhaust chamber 38 and out through a supply exhaust opening 34. Once again, a user may adjust the predetermined pressure set point by utilizing a tool on the adjustment screw 12. In the illustrated embodiment, the user may use a flathead screwdriver to adjust the position of the adjustment screw 12. However, any other screwdriver, alien wrench, or other tool format able to provide the appropriate torque on the adjustment screw 12 may be utilized.

Referring to FIGS. 1 and 2 simultaneously, in operation the device 10 is shown in its “fully open” position, which allows the maximum amount of airflow through the device 10, from the supply port 36 to the supply exhaust opening 34. In this fully open position, the pressure pump 42 delivers the lowest amount of pressure possible to the output chamber 46, as the convoluted diaphragm 28 is not creating a seal with the sealing ring 32 to close the supply port 36. As the adjustment spring 18 is compressed by adjustment of the adjustment screw 12 or by loss of pressure in the system 40, it forces the convoluted diaphragm 28 down until it covers the sealing ring 32 (FIG. 3). Referring now to FIGS. 1 and 3 simultaneously, this blocks the path of air out of the device 10, which allows all of the airflow to be sent to the output chamber 46 via the system air line 48. Once the pressure approaches its desired setting, the convoluted diaphragm 28 is pushed up, away from the sealing ring 32 and allows some of the air from the pressure pump 42 to be exhausted to atmosphere through the supply exhaust opening 34. The convoluted diaphragm 28 will move up until equilibrium is reached between the force of the compressed adjustment spring 28 pushing in one direction and the force of the pressurized air in the opposite direction, as shown in FIG. 2.

Referring again to FIGS. 1 and 3 simultaneously, a convoluted diaphragm 28 is used in this device 10 to allow the convoluted diaphragm 28 to move into its desired position more readily than a flat diaphragm (not shown), thus giving the device 10 more precision. The U-shaped portions 30 of the convoluted diaphragm 28 allow for an amount of slack in the convoluted diaphragm 28. This slack created by the U-shaped portions 30 allows for greater ease of movement of the convoluted diaphragm 28 between the positions shown in FIGS. 2 and 3, but also causes some vibration in the convoluted diaphragm 28. In order to remedy this vibration caused by having a convoluted diaphragm 28, the referenced atmosphere opening 20 must have an appropriate position and sizing on the spring cavity housing 37. Creating such a referenced atmosphere opening 20 with appropriate sizing and placement on the housing 37 will eliminate vibration of the convoluted diaphragm 28.

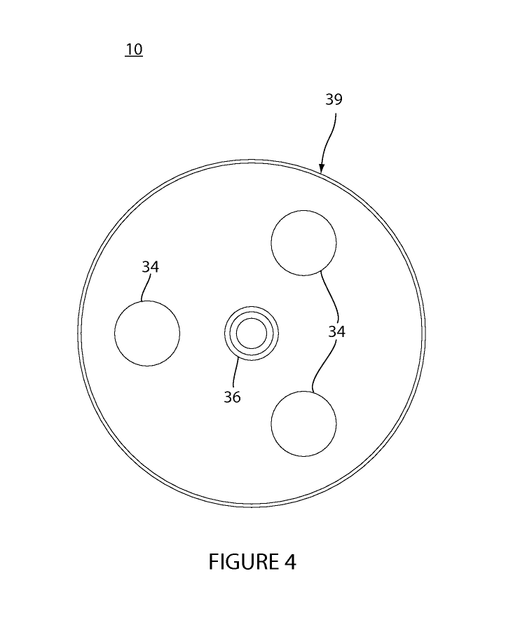

It should also be noted here that the position of the supply port 36, i.e., the supply port 36 being centered with respect to the convoluted diaphragm 28, and positioning the supply exhaust opening 34 to the side of the supply port 36, allows for a more uniform air flow from the supply port 36 to the convoluted diaphragm 28, also assisting in eliminating vibration of the convoluted diaphragm 28. As will be discussed below, an embodiment including a plurality of exhaust openings 34 (FIG. 4) further allows for a more uniform air flow from the supply port 36 to the convoluted diaphragm 28.

Many times during this “equilibrium” state, prior art diaphragms tend to vibrate and not only cause the setpoint to vary, but also create an audible noise. As discussed above, a properly sized and located reference to atmosphere opening 20 in the device 10 assists in further eliminating this vibration. When this opening 20 is properly sized and located, it acts as a “muffler” to dampen out any natural frequency that would otherwise occur and eliminate any residual vibration in the convoluted diaphragm 28. This correction for any residual vibrating in the convoluted diaphragm 28 is what makes the device extremely accurate in low pressure/high flow applications.

The reference to atmosphere opening 20 on the side end of the device 10 ensures that atmospheric pressure is maintained in the cavity housing 37 of the adjustment spring 18. This ensures a more accurate device 10, in that without a reference to atmosphere opening 20, air pressure would vary in the cavity housing 37 of the adjustment spring 18 when the convoluted diaphragm 28 changed positions. With the reference to atmosphere opening 20, the adjustment spring 18 is the only element creating a bias against the convoluted diaphragm 28. This allows the pressure to be adjusted by adjusting the compression on the adjustment spring 18 with the adjustment screw 12 only.

Referring back to FIG. 1, a pressure gauge 44 is also connected to the system air line 48 of the system 40 in a T configuration in order to properly calibrate and/or adjust the device 10. The pressure gauge 44 allows a user of the system 40 to measure and record the pressure in the system 40 while adjusting the adjustment screw 12 (FIGS. 2 and 3) of the device 10. Additional embodiments (not shown) may include a device 10 that has an integrated pressure gauge 44 with two “T” lines running from the device 10 to the system air line 48, or a pressure gauge 44 configured in another component of the system 40.

Referring to FIG. 4, a device of the present application is illustrated from a bottom perspective. Here, the bottom of the base portion 39 of the device 10 is illustrated including the supply port 36 and a plurality of exhaust openings 34. As discussed above, the device 10 may include a single exhaust opening 34, or any number of exhaust openings 34 configured in the base portion. It should be noted that further embodiments may include any number of exhaust openings in a variety of patterns on the bottom of the device 10 or fashioned into other surfaces of the base portion 39. In the illustrated embodiment of FIG. 4, three exhaust openings 34 are configured 120 degrees apart from each other relative to the supply port 36, and the exhaust openings 34 are equidistant to the supply port 36. This configuration causes a more uniform flow of air from the supply port 36 through the exhaust chamber 38 and out of the device 10 through the exhaust openings 34. This uniform flow assists in eliminating the vibration of the convoluted diaphragm 28.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A pressure regulator device, the device comprising:
a base portion having a supply port and a convoluted diaphragm, a u-shaped portion at an attachment point to the base portion, the convoluted diaphragm secured to seal the supply port from an exhaust chamber in the base portion with a bias force from a compressed adjustment spring, the convoluted diaphragm further moving in a path opposite the bias in response to a predetermined pressure level at the supply port, wherein pressure is released through the exhaust chamber to an exhaust opening in the base when the predetermined pressure level is reached; and
a spring cavity housing secured to the base portion and housing the compressed adjustment spring, the spring cavity including a reference to atmosphere opening in order to maintain atmospheric pressure in the spring cavity housing.

2. The pressure regulator device of claim 1, wherein the convoluted diaphragm includes a u-shaped portion at an attachment point to the base portion.

3. The pressure regulator device of claim 1, wherein the base portion includes a plurality of exhaust openings, fashioned equidistant from the supply port.

4. The pressure regulator device of claim 1, wherein the plurality of exhaust openings are spaced 120° apart.

5. The pressure regulator device of claim 1, further comprising an adjustment screw fashioned at an end of the spring cavity housing opposite the base portion, the adjustment screw configured to compress the adjustment spring in order to increase or decrease the bias force in the adjustment spring, wherein the bias force in the adjustment spring corresponds to the predetermined pressure level.

6. The pressure regulator device of claim 1, further comprising a sealing ring fashioned on an inner surface of the base portion, and further fashioned to maintain contact with the convoluted diaphragm thus sealing the exhaust chamber from the supply port when the predetermined pressure level is not reached.

7. The pressure regulator device of claim 1, further comprising a spring guide in direct contact with the convoluted diaphragm, and in contact with the adjustment spring thus acting as a connector between the adjustment spring and the convoluted diaphragm.

8. The pressure regulator device of claim 2, wherein the u-shaped portion provides the convoluted diaphragm with a greater range of motion from the closed position to an open position.

9. The pressure regulator device of claim 1, wherein the reference to atmosphere opening operates to prevent an additional air pressure force from adding to the bias force.

10. The pressure regulator device of claim 1, wherein the supply port is connected to a low pressure/high flow air system.

11. A pressure regulator device, the device comprising:
a base portion having a supply port and a convoluted diaphragm, the convoluted diaphragm secured to seal the supply port from an exhaust chamber in the base portion with a bias force from a compressed adjustment spring, the convoluted diaphragm further moving in a path opposite the bias in response to a predetermined pressure level at the supply port, wherein pressure is released through the exhaust chamber to a plurality of exhaust openings in the base; and
a spring cavity housing secured to the base portion and housing the compressed adjustment spring.

12. The pressure regulator device of claim 11, wherein the spring cavity includes a reference to atmosphere opening in order to maintain atmospheric pressure in the spring cavity housing.

13. The pressure regulator device of claim 11, wherein the plurality of exhaust openings are fashioned equidistant from the supply port.

14. The pressure regulator device of claim 13, wherein the plurality of exhaust openings are spaced 120° apart.

15. The pressure regulator device of claim 11, further comprising an adjustment screw fashioned at an end of the spring cavity housing opposite the base portion, the adjustment screw configured to compress the adjustment spring in order to increase or decrease the compression of the adjustment spring, wherein the compression in the adjustment spring corresponds to the predetermined pressure level.

16. The pressure regulator device of claim 11, further comprising a sealing ring fashioned on an inner surface of the base portion, and further fashioned to maintain contact with the convoluted diaphragm thus sealing the exhaust chamber from the supply port when the predetermined pressure level is not reached.

17. The pressure regulator device of claim 11, further comprising a spring guide in direct contact with the convoluted diaphragm, and in contact with the adjustment spring thus acting as a connector between the adjustment spring and the convoluted diaphragm.

18. The pressure regulator device of claim 11, wherein the convoluted diaphragm includes a u-shaped portion, wherein the u-shaped portion provides the convoluted diaphragm with a greater range of motion from the closed position to an open position.

19. The pressure regulator device of claim 12, wherein the reference to atmosphere opening operates to prevent an additional air pressure force from adding to the bias force.

20. The pressure regulator device of claim 11, wherein the supply port is connected to a low pressure/high flow air system.

21. A pressure regulator device, the device comprising:
a base portion having a supply port and a convoluted diaphragm having a u-shaped portion at an attachment point to the base portion, the convoluted diaphragm secured to seal the supply port from an exhaust chamber in the base portion with a bias force from an adjustment spring, the convoluted diaphragm further moving in a path opposite the bias in response to a predetermined pressure level at the supply port, wherein pressure is released through the exhaust chamber to a plurality of exhaust openings in the base when the predetermined pressure level is reached, wherein the plurality of exhaust openings are fashioned equidistant from the supply port and are spaced 120° apart; and
a spring cavity housing secured to the base portion and housing the compressed adjustment spring, the spring cavity including a reference to atmosphere opening in order to maintain atmospheric pressure in the spring cavity housing, wherein the reference to atmosphere opening operates to prevent an additional air pressure force from adding to the bias force.
